(19) United States
(12) Patent Application Publication
(10) Pub. No.: US 2007/0006319 A1
(43) Pub. Date: Jan. 4, 2007

(54) Method and apparatus to facilitate message transmission and reception using multiple forms of message alteration

(76) Inventors: James J. Fitzgibbon, Batavia, IL (US); Edward T. Laird, Lombard, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/172,524

(22) Filed: Jun. 30, 2005

(51) Int. Cl. H04L 9/32

(52) U.S. Cl. 726/27

(57) ABSTRACT

One provides (101) message content comprising at least a first message content part and a second message content part. One then selects (103) (at least) a first and second form of message alteration wherein each form of message alteration has corresponding recovery content that can be used to facilitate recovering message content that has been altered using the respective form of message alteration. The first message content part, in combination with recovery content as corresponds to the second form of message alteration, is then converted (104) into a first altered form using the first form of message alteration. In addition, one also preferably converts (105) the second message content part into a second altered form using the second form of message alteration. The first and second altered forms, in addition to recovery content as corresponds to the first form of message alteration, are then transmitted (106) as a joint message.

### TECHNICAL FIELD

This invention relates generally to message transmission and reception techniques and more particularly to the relatively secure conveyance of message contents.

### BACKGROUND

Various means of conveying messages are known in the art. In many cases an interest exists in preserving or otherwise maintaining at least some degree of security with respect to conveyance of the message. For example, in some cases it may be desired to prevent an eavesdropping party from gleaning the substantive content of the message. In other cases, as when the message comprises, at least in part, an instruction, command, or similar content it may be desirable to prevent an unauthorized party from effectively transmitting an unauthorized message in order to prevent instigation of unauthorized action by the receiving entity.

For example, movable barrier operators (such as but not limited to garage door openers) often respond to receipt of a wireless remote control signal. In particular, the movable barrier operator will often move a corresponding movable barrier between closed and opened positions in response to such remote control signals. In such a case it often behooves the system operator to seek to ensure that the movable barrier operator will not respond to a remote control signal when transmitted from an unauthorized transmission source.

In some cases the movable barrier operator expects to see a unique identifier or other code in conjunction with, or in lieu of, a specific remote control command. This approach provides at least some degree of security though a more sophisticated unauthorized party may be able to themselves receive such a transmission and co-opt the identifier/code for their own future unauthorized use. With this in mind, so-called rolling codes are often employed to frustrate this approach to breaching the security of such a system. With rolling codes, the code itself changes on a frequent basis pursuant to a plan (such as an implementing algorithm) known to both the transmitter and the receiver. Without knowledge of the underlying scheme by which a next code is selected, an unauthorized party who gains access to a presently used code or identifier will still remain unable to leverage that knowledge in support of effecting unauthorized control over the receiver.

There may be instances, however, when additional security may be desired or appropriate. For example, a given rolling code instantiation may be open to brute force attacks or other weaknesses due to local and/or otherwise unique circumstances.

### BRIEF DESCRIPTION OF THE DRAWINGS

The above needs are at least partially met through provision of the method and apparatus to facilitate message transmission and reception using multiple forms of message alteration described in the following detailed description, particularly when studied in conjunction with the drawings, wherein:

FIG. 1 comprises a flow diagram as configured in accordance with various embodiments of the invention;

FIG. 2 comprises a schematic view of a data format as configured in accordance with various embodiments of the invention;

FIG. 3 comprises a schematic view of a data format as configured in accordance with various embodiments of the invention;

FIG. 4 comprises a schematic view of a data format as configured in accordance with various embodiments of the invention;

FIG. 5 comprises a schematic view of a data format as configured in accordance with various embodiments of the invention;

FIG. 6 comprises a schematic view of a data format as configured in accordance with various embodiments of the invention;

FIG. 7 comprises a schematic view of a data format as configured in accordance with various embodiments of the invention;

FIG. 8 comprises a schematic view of a data format as configured in accordance with various embodiments of the invention;

FIG. 9 comprises a flow diagram as configured in accordance with various embodiments of the invention;

FIG. 10 comprises a block diagram as configured in accordance with various embodiments of the invention;

FIG. 11 comprises a block diagram as configured in accordance with various embodiments of the invention; and

FIG. 12 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides message content comprising at least a first message content part and a second message content part. One then selects (at least) a first and second form of message alteration herein each form of message alteration has corresponding recovery content that can be used to facilitate recovering message content that has been altered using the respective form of message alteration. The first message content part, in combination with recovery content as corresponds to the second form of message alteration, are then converted into a first altered form using the first form of message alteration. In addition, one also preferably converts the second message content part into a second altered form using the second form of message alteration. The first and second altered forms, in addition to recovery content as corresponds to the first form of message alteration, are then transmitted as a joint message.

The joint message can assume any of a wide variety of forms. For example, depending upon needs and/or requirements, the joint message can comprise a single contiguous message or can comprise a plurality of discrete transmissions. The recovery identifier and the message content can be discrete with respect to one another or can, if desired, be at least partially integrated with one another.

These teachings are usable with a wide variety of different forms of message alteration and hence can provide benefits with a large number of platforms having transmission/reception and/or signal processing agility of various kinds. It will also be seen that these teachings can be employed in conjunction with more traditional identifier/code based techniques including specifically rolling code-based techniques. So configured, security can be increased and often dramatically so. In particular, an unauthorized party will face increased difficulty with respect to viably monitoring the communications of such a system. An unauthorized party will also likely face increased difficulty with respect to accommodating and matching the transmission/reception and/or signal processing agility of the resultant system.

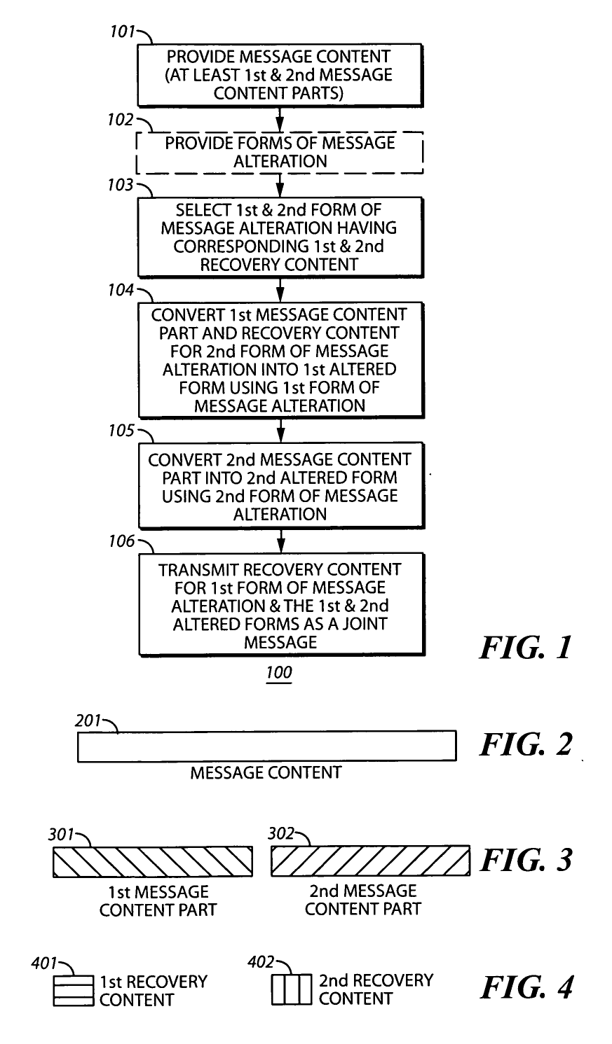

These and other benefits may become clearer upon making a thorough review and study of the following detailed description. Referring now to the drawings, and in particular to FIG. 1, an exemplary process 100 provides 101 message content to be transmitted (for example, from a wireless remote control device to a movable barrier operator). With momentary reference to FIG. 2, this message content 201 can comprise essentially any substantive or non-substantive content of essentially any nature, type, or length as may be desired and/or as may be appropriate to accommodate the needs and/or limitations of a given application setting. For example, when the message content comprises remote control signaling, the message content may more specifically comprise an identifier for at least one of the transmitting platform, the receiving platform, the communication system to which one or more of these elements belongs, and/or a particular communication system user (such as an individual, a particular group of individuals, a business, or some other entity of interest). As another example, in accordance with prior art practice this message content can also comprise, if desired, one or more rolling codes.

Referring now momentarily to FIG. 3, in a preferred approach this message content comprises at least a first message content part 301 and a second message content part 302. The message content can be parsed as desired to provide these message content parts. As one example, the message content can be parsed to delineate, at least in part, its discrete substantive content. To illustrate, this could be done when the message content comprised both an identifier and an operational code. In such a case the identifier could comprise the first message content part 301 and the operational code could comprise the second message content part 302. As another example, the message content can be parsed without reference to the substantive content of that message. To illustrate, the message content could simply comprise an identifier and the first message content part 301 could comprise a first portion of that identifier and the second message content part 302 could comprise a second portion of that identifier.

Referring again to FIG. 1, in an optional but preferred approach, this process 100 also provides for provision 102 of a plurality of different forms of message alteration. These forms of message alteration pertain to different ways and/or means of modifying an input message to thereby yield a predictable altered version thereof as an output. Relevant examples of forms of message alteration comprise, but are not limited to:
a plurality of candidate data rates;
a plurality of candidate spread spectrum practices (including but not limited to various spreading codes, frequency hopping patterns and/or usable (or unusable) channels, and so forth);
a plurality of candidate carrier modulations (including but not limited to frequency modulation, amplitude modulation, phase modulation, direct sequencing spread spectrum, frequency hopping spread spectrum, single sideband, vestigial sideband, and so forth);
a plurality of candidate carrier frequencies (including but not limited to specific center frequencies and corresponding information such as, but not limited to, channel width, guard band presence and/or width, and so forth);
a plurality of candidate joint message formats (including but not limited to integral formats, parsed formats, and so forth as will be described below in more detail);
a plurality of candidate data orders (where, for example, the order is changed for all remaining portions of the message, only a portion of the remaining message, or follows a pattern per message position);
a plurality of candidate data inversion patterns (where, for example, the inversion can be for the rest of the message, for a portion of the message, and/or follows a pattern per message position);
a plurality of candidate data symbols representing a data value (where, for example, the representation is modified for the whole message, a specific portion of the message, and/or follows a pattern per message position);
a plurality of candidate modes of encryption;
a plurality of candidate encryption keys.

In a preferred approach each of these forms of message alteration has a corresponding (or at least partially corresponding) substantially unique recovery identifier (where, for example, a given recovery identifier correlates to and therefore essentially serves to identify a specific one of the forms of message alteration as was provided above). Accordingly, it will be understood that these recovery identifiers can comprise, but are not limited to:
particular data rate identifiers;
particular spread spectrum practice identifiers;
particular carrier modulation identifiers;
particular carrier frequency identifiers;
particular joint message format identifiers;
particular data order identifiers;
particular data inversion pattern identifiers;
particular symbol pattern identifiers;
a particular data symbol or data symbol set;
a particular mode of encryption;
a particular encryption key;
   and so forth, to name but a few.

The recovery identifier can comprise, for example, a simple code where a specific value, such as a binary value, corresponds to a particular form of message alteration. As a simplified example, when only two forms of message alteration are provided, a one-bit value will serve to identify and differentiate between these forms of message alteration. To illustrate, a value of “0” can correlate to a first form of message alteration while a value of “1” can correlate to the second form of message alteration. It would be possible, for example, for each recovery identifier to essentially point to a specific entry in a lookup table, where the specific entry itself defines the corresponding form of message alteration.

If desired, the recovery identifier can share functionality and meaning in support of other content or capability. As an illustration, all or part of a rolling code can also serve as a recovery identifier. For example, and to continue the simple example presented above, the least significant bit of a rolling code can also serve to identify each of two provided forms of message alteration.

Pursuant to this process 100, one then selects 103 a first and second form of message alteration. This selection step 103 can be carried out in any of a wide variety of ways with a specific approach likely being dictated by the needs and/or limitations inherent to a given application context. As one example, the particular forms of message alteration can be selected essentially at random. As another example the particular forms of message alteration can be selected pursuant to a pre-determined selection pattern. The selection itself can be the result of a specific selection process or can be a part of another process (as when the particular forms of message alteration selected are dependent upon the least significant bit (or bits) of a rolling code as is derived via its own derivation process).

As noted above, these first and second forms of message alteration will each have a corresponding recovery identifier associated therewith. Accordingly (and referring momentarily to FIG. 4), upon selecting a first and second form of message alteration as described above, there will also be corresponding first recovery content 401 and second recovery content 402 as relate specifically to the first and second forms of message alteration, respectively.

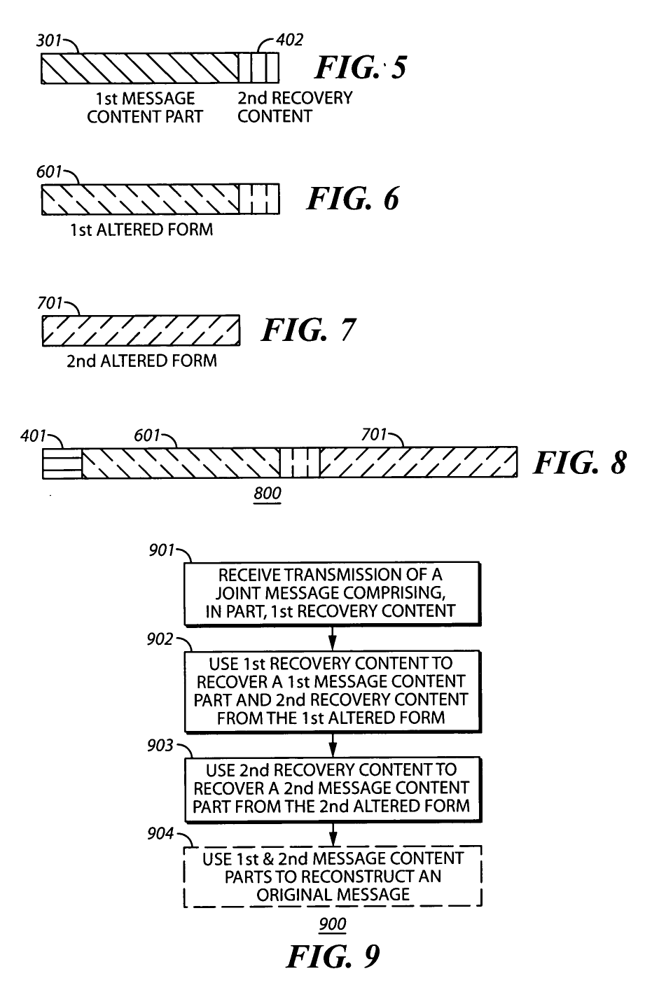

Returning again to FIG. 1, this process 100 next provides for converting 104 both the first message content part and the second recovery content into a first altered form using the first form of message alteration as was earlier selected. With momentary reference to FIG. 5, in a preferred embodiment this step comprises combining the first message content part 301 with the second recovery content 402 via some combination technique of choice. As one example one of these informational elements can simply be concatenated with the other informational element as is suggested by the illustration of FIG. 5. As another example the individual bits (or other informational symbols) as comprise these informational elements can be interleaved with one another. Other examples are also possible (for example, convolutional encoding might be employed to effect their combination) as will be recognized and understood by those skilled in the art.

Referring now momentarily to FIG. 6, this combination of the first message content part 301 and the second recovery content 402 is then altered as described (using the first form of message alteration as was selected above) to yield a resultant first altered form 601. As one illustrative example, when the first form of message alteration comprises a particular way of ordering data, the information symbols as comprise the combined first message content part 301 and the second recovery content 402 are altered in accordance with that particular way of ordering data. As another illustrative example, when the first form of message alteration comprises a particular approach to encryption, the information symbols as comprise the combined first message content part 301 and the second recovery content 402 are altered via that corresponding particular approach to encryption. Countless other examples are of course possible.

Returning again to FIG. 1, this process 100 then provides for converting 105 the second message content part into a second altered form using the second form of message alteration. To continue with the schematic representation provided above, and referring momentarily to FIG. 7, the second message content part 302 as was depicted earlier with reference to FIG. 3 is now altered to yield a resultant second altered form 701.

Referring again to FIG. 1, this process 100 then provides for transmission 106 (via a wireless or wired channel of choice) of a joint message that comprises (as is schematically represented in FIG. 8) the first recovery content 401 as corresponds to the first form of message alteration, the first altered form 601 (which contains an altered representation of both the first message content part 301 and the second recovery content 402), and the second altered form 701 (which comprises an altered representation of the second message content part 302).

If desired, the joint message can comprise transmission of a contiguous aggregation of the first recovery content, the first altered form, and the second altered form (i.e., a transmission of an aggregation of these elements such as that which is illustrative depicted in FIG. 8). It is also possible, however, for the joint message to be transmitted as a plurality of discrete messages. In such a case, for example, the first recovery content can be transmitted separate and distinct from the remaining portions of the joint message. The nature of this separation can vary with the needs and/or limitations of a given application setting. Useful examples include, but are not limited to, separation by time (as when the individual joint message portions are sent at considerably different times), carrier characteristics (as when the individual joint message portions are sent using different forms of message alterations as pertain to the carrier), specific bit patterns, and/or a specific quantity of bits.

Referring now to FIG. 9, a corresponding receive process 900 preferably begins with reception 901 of a transmitted joint message (such as those described above) comprising, at least in part, the first recovery content. This process 600 then facilitates selection 602 of a particular way of receiving a transmission of another portion of that joint message (which portion comprises, for example, at least a portion of the message content). This process 900 then prompts use 902 of this recovered first recovery content to facilitate recovery of the first message content part and the second recovery content. More particularly, the first recovery content can be employed to identify that the first message content part and the second recovery content have been altered into the first altered form using the form of message alteration that correlates to the first recovery content. This, in turn, then facilitates selection and use of the appropriate reception and/or processing technique or means to accurately return this altered content back into its original form (i.e., the first message content part and the second recovery content).

This process 900 then provides for use 903 of the recovered second recovery content to effect recovery of the second message content part. Again, this may be done by using the second recovery content to identify which form of message alteration had been used to alter the second message content part into the second altered form as comprises a part of the received joint message and then using that information to effect an appropriate return of that altered content back into its original form (i.e., the second message content part).

In an optional though preferred approach, this process 900 can then provide for use 904 of the recovered first message content part and the second message content part to reconstruct the original message. For example, when the first and second message content parts were formed by a simple severing of the original message, the original message can be restored by simply rejoining the first and second message content parts in the correct order. Subsequent processing will then depend, of course, upon the nature and substance of the original message. For example, when the original message comprises remote control signaling, that recovered remote control signaling can then be processed as desired to identify, verify, and/or act upon the instruction represented thereby.

So configured, a considerable increase in security occurs. In particular, it becomes increasingly difficult for an unauthorized party to spoof the receiver as mere data alone is insufficient to cause proper reception of the message content. Instead, considerable agility and flexibility with respect to types of transmission/reception and/or signal processing must also be supported.

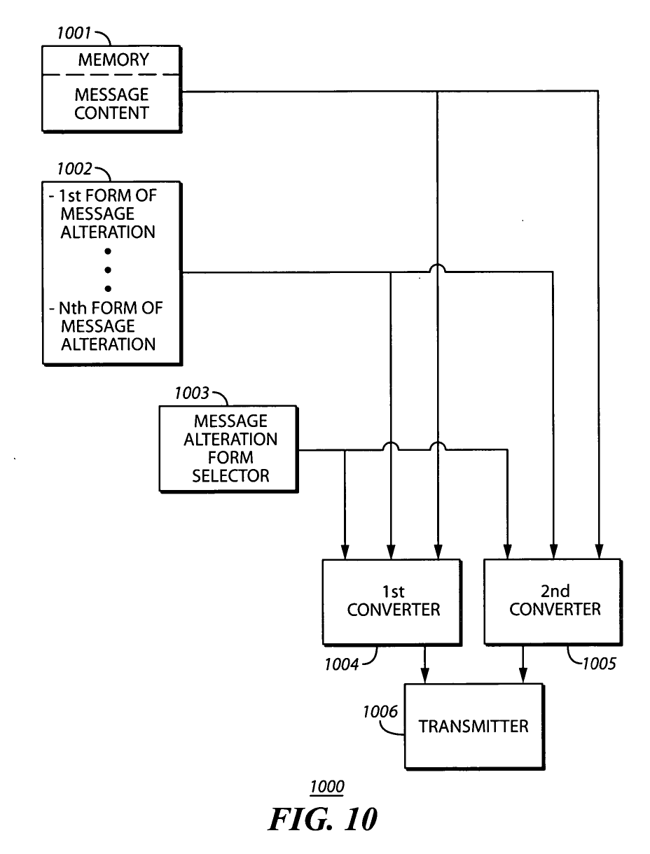

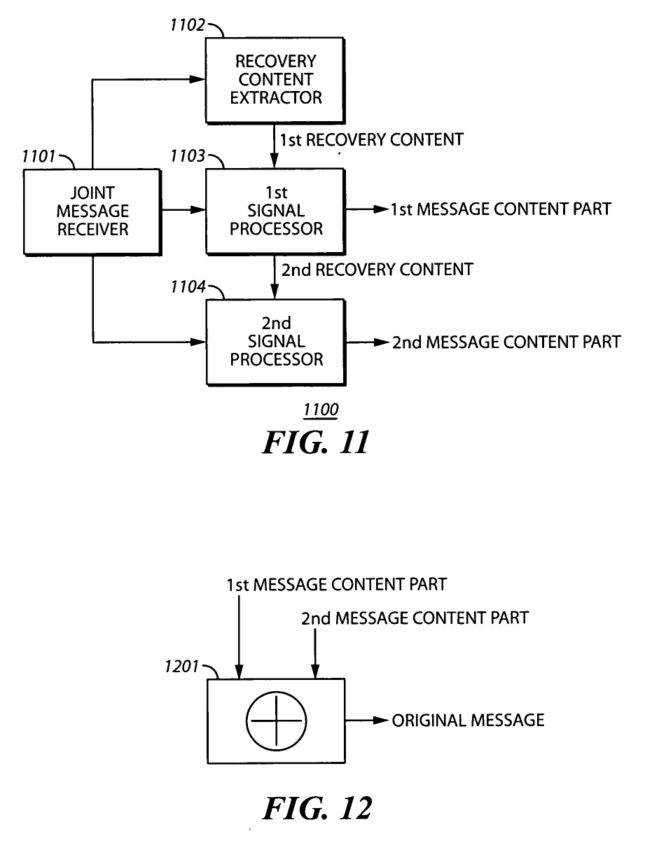

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 10, an illustrative approach to a particular transmission platform will be provided.

This transmission platform 1000 comprises a memory 1001 that contains the above described message content (comprising, in particular, message content having at least a first and a second message content part). This transmission platform 1000 further preferably comprises a plurality of selectable forms of message alteration 1002 (such as those described above and as represented here by a first through an Nth form of message alteration where “N” comprises an integer greater than “1”). As described above, at least some of these selectable forms of message alteration have corresponding recovery content associated therewith, which recovery content can be used to facilitate recovering message content that has been altered as per a selected one of the selectable forms of message alteration. This transmission platform 1000 also preferably comprises a message alteration form selector 1003 which serves to automatically select at least a first and a second form of message alteration that are different from one another as per the teachings set forth above.

Each of these components then operably couples to a first and a second converter 1004 and 1006. These converters are responsive to these components and are more particularly configured and arranged to convert incoming message content portions (and recovery content where provided) into corresponding altered forms using selected forms of message alteration. For example, and as per the teachings set forth herein, the first converter 1004 can serve to use a first form of message alteration as is selected by the message alteration form selector 1003 to alter a first message content portion as is provided by the memory 1001 and a first recovery content as corresponds to a second form of message alteration as is also selected by the message alteration form selector 1003 into a first altered form. The second converter 1005 can serve to use the second form of message alteration to alter a second message content portion as is provided by the memory 1001 into a second altered form.

These altered form outputs of the first and second converter 1004 and 1005 are then provided to a transmitter 1006 which effects their transmission, along with the first recovery content, as a joint message as described above. In a preferred approach a single dynamically configurable transmitter serves this purpose. If desired, however, the transmitter 1006 can comprise a plurality of discrete transmitters that differ from one another as necessary to support the intended functionality of the resultant platform. In a preferred embodiment this transmitter 1006 comprises a wireless transmitter though other configurations are possible.

The above-described elements can comprise discrete components if desired. It is also possible, however, to view the transmission platform 1000 presented in FIG. 10 as a logical view where one or more of these elements are realized via shared facilities. For example, it may be useful for many applications to use a wholly or partially programmable platform such as a microprocessor to effect at least some of the described functionality. It may also be useful, at least in some application settings as when the transmission platform 1000 comprises a wireless remote control for a movable barrier operator, to further provide for a user interface (such as, but not limited to, one or more user-assertable buttons, switches, keys, a touch screen, or the like). Such an interface can serve, for example, as a triggering mechanism to begin the described processes.

Referring now to FIG. 11, an illustrative approach to a particular reception platform will be provided. In this illustrative embodiment the reception platform 1100 comprises a joint message receiver 1101 (for example, a wireless receiver) that is preferably capable of receiving various selectable types of transmissions wherein these selectable types of transmissions differ from one another as a function, at least in part, of corresponding forms of message alterations as have been presented above. As with the above-described transmitter, this receiver 1101 can comprise a single selectively agile platform in this regard or can itself be comprised of a plurality of discrete receivers that each support some, but not all, of a variety of types of transmission as may correspond to certain forms of message alteration. Pursuant to these teachings, this receiver 1101 is configured and arranged to facilitate compatible reception of a joint message such as those described herein.

This joint message receiver 1101 operably couples to a recovery content extractor 1102 that serves to recover the first recovery content as comprises a part of the joint message and to provide that information via a first recovery content output. The latter couples to a first signal processor 1103 that also receives at least relevant portions of the joint message from the joint message receiver 1101 and that serves to use the first recovery content as is provided by the recovery content extractor 1102 to recover from the joint message the first message content part and the second recovery content as were both converted into a first altered form using the first form of message alteration as was described above.

A second signal processor 1104 receives the second recovery content from the first signal processor 1103 and also at least relevant portions of the joint message from the joint message receiver 1101. This second signal processor 1104 then uses the second recovery content to recover from the joint message the second message content as had previously been converted into the second altered form using the second form of message alteration as was also described above. So configured, the receiving platform 1100 is able to successfully recover both the first and second message content parts. If desired, and referring now to FIG. 12, a combiner 1201 can be used to combine (as appropriate) these recovered first and second message content parts to thereby yield a resultant reconstruction of the original message.

So configured, a transmitter and a corresponding receiver can each readily support the teachings set forth herein. In particular, a plurality of differing forms of message alteration are selectively usable to effectively encode (in a manner of speaking) message content to be conveyed between the transmitter and the receiver (which message content may comprise, for example, an instruction to be carried out via the receiver). The receiver determines the particular types of information recovery technique to employ when receiving the transmission of the message content based, at least in part, upon the first recovery content and also the second recovery content (wherein the first recovery content is employed to facilitate recovery of the second recovery content).

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, for the sake of clarity, only a first and second message part has, for the most part been referred to in the detailed description. This, in turn, prompted discussion of only a first and second form of message alteration to be used therewith. These teachings are readily scalable, however, to accommodate a greater number of message concept parts and corresponding forms of message alteration as will be evident to those skilled in the art.

We claim:

1. A method comprising:
providing message content comprising at least a first message content part and a second message content part;
selecting a first and a second form of message alteration, wherein:
the first form of message alteration has first recovery content corresponding thereto to be used to facilitate recovering message content that has been altered as per the first form of message alteration;
the second form of message alteration has second recovery content corresponding thereto to be used to facilitate recovering message content as has been altered as per the second form of message alteration;
converting the first message content part and the second recovery content into a first altered form using the first form of message alteration;
converting the second message content part into a second altered form using the second form of message alteration;
transmitting the first recovery content, the first altered form, and the second altered form as a joint message.

2. The method of claim 1 wherein the message content comprises remote control signaling.

3. The method of claim 1 further comprising providing a plurality of different forms of message alteration and wherein selecting a first and a second form of message alteration comprises selecting at least one of the first and second form of message alteration from the plurality of different forms of message alteration.

4. The method of claim 3 wherein the plurality of different forms of message alteration comprise at least one of:
a plurality of candidate data rates;
a plurality of candidate spread spectrum practices;
a plurality of candidate carrier modulations;
a plurality of candidate carrier frequencies;
a plurality of candidate joint message formats;
a plurality of candidate data orders;
a plurality of candidate data inversion patterns;
a plurality of candidate modes of encryption;
a plurality of candidate encryption keys.

5. The method of claim 1 wherein at least one of the first and second recovery content comprises at least one of:
a particular data rate identifier;
a particular spread spectrum practice identifier;
a particular carrier modulation identifier;
a particular carrier frequency identifier;
a particular joint message format identifier;
a particular data order identifier;
a particular data inversion pattern identifier;
a particular data symbol or data symbol set;
a particular mode of encryption;
a particular encryption key.

6. The method of claim 1 wherein transmitting the joint message comprises transmitting a contiguous aggregation of the first recovery content, the first altered form, and the second altered form.

7. The method of claim 1 wherein transmitting a joint message comprises transmitting a plurality of discrete messages.

8. The method of claim 8 wherein the plurality of discrete messages are separated from one another by at least one of:
time;
carrier characteristics;
specific bit patterns
a specific quantity of bits.

9. The method of claim 1 wherein the message content comprises, at least in part, an identifier for at least one of:
a transmitting platform;
a receiving platform;
a communication system;
a communication system user.

10. A method comprising:
receiving a transmission of a joint message comprising, in part, first recovery content;
using the first recovery content to recover from the joint message a first message content part and second recovery content as was converted into a first altered form using a first form of message alteration;
using the second recovery content to recover from the joint message a second message content part as was converted into a second altered form using a second form of message alteration, which second form of message alteration is different than the first form of message alteration.

11. The method of claim 10 further comprising using the first message content part and the second message content part to reconstruct an original message.

12. The method of claim 11 wherein the original message comprises, at least in part, remote control signaling.

13. The method of claim 10 wherein the first form of message alteration differs from the second form of message alteration with respect to at least one of:
a data rate;
a spread spectrum practice;
a carrier modulation;
a carrier frequency;
a joint message format;
a data order;
a data inversion pattern;
a data symbol representing a data value;
a mode of encryption;
an encryption key.

14. The method of claim 10 wherein at least one of the first recovery content and the second recovery content comprises at least one of:
a particular data rate identifier;
a particular spread spectrum practice identifier;
a particular carrier modulation identifier;
a particular carrier frequency identifier;
a particular joint message format identifier;
a particular data order identifier;
a particular data inversion pattern identifier;
a particular data symbol or data symbol set;
a particular mode of encryption;
a particular encryption key.

15. An apparatus comprising:
means for providing message content comprising at least a first message content part and a second message content part;
means for selecting a first and a second form of message alteration, wherein:
the first form of message alteration has first recovery content corresponding thereto to be used to facilitate recovering message content that has been altered as per the first form of message alteration;
the second form of message alteration has second recovery content corresponding thereto to be used to facilitate recovering message content as has been altered as per the second form of message alteration;
means for converting the first message content part and the second recovery content into a first altered form using the first form of message alteration;
means for converting the second message content part into a second altered form using the second form of message alteration;
means for transmitting the first recovery content, the first altered form, and the second altered form as a joint message.

16. The apparatus of claim 15 wherein the message content comprises remote control signaling.

17. The apparatus of claim 15 further comprising means for providing a plurality of different forms of message alteration and wherein the means for selecting a first and a second form of message alteration comprises means for selecting at least one of the first and second form of message alteration from the plurality of different forms of message alteration.

18. The apparatus of claim 17 wherein the plurality of different forms of message alteration comprise at least one of:
a plurality of candidate data rates;
a plurality of candidate spread spectrum practices;
a plurality of candidate carrier modulations;
a plurality of candidate carrier frequencies;
a plurality of candidate joint message formats;
a plurality of candidate data orders;
a plurality of candidate data inversion patterns;
a plurality of candidate data symbols representing a data value;
a plurality of candidate modes of encryption;
a plurality of candidate encryption keys.

19. The apparatus of claim 15 wherein at least one of the first and second recovery content comprises at least one of:
a particular data rate identifier;
a particular spread spectrum practice identifier;
a particular carrier modulation identifier;
a particular carrier frequency identifier;
a particular joint message format identifier;
a particular data order identifier;
a particular data inversion pattern identifier;
a particular data symbol or data symbol set;
a particular mode of encryption;
a particular encryption key.

20. The apparatus of claim 15 wherein the means for transmitting the joint message comprises means for transmitting a contiguous aggregation of the first recovery content, the first altered form, and the second altered form.

21. The apparatus of claim 15 wherein the means for transmitting a joint message comprises means for transmitting a plurality of discrete messages.

22. The apparatus of claim 21 wherein the plurality of discrete messages are separated from one another by at least one of:
time;
carrier characteristics;
specific bit patterns
a specific quantity of bits.

23. The apparatus of claim 15 wherein the message content comprises, at least in part, an identifier for at least one of:
a transmitting platform;
a receiving platform;
a communication system;
a communication system user.

24. An apparatus comprising:
means for receiving a transmission of a joint message comprising, in part, first recovery content;
means for using the first recovery content to recover from the joint message a first message content part and second recovery content as was converted into a first altered form using a first form of message alteration;
means for using the second recovery content to recover from the joint message a second message content part as was converted into a second altered form using a second form of message alteration, which second form of message alteration is different than the first form of message alteration.

25. The apparatus of claim 24 further comprising means for using the first message content part and the second message content part to reconstruct an original message.

26. The apparatus of claim 25 wherein the original message comprises, at least in part, remote control signaling.

27. The apparatus of claim 24 wherein the first form of message alteration differs from the second form of message alteration with respect to at least one of:
a data rate;
a spread spectrum practice;
a carrier modulation;
a carrier frequency;
a joint message format;
a data order;
a data inversion pattern;
a data symbols set;
a mode of encryption;
an encryption key.

28. The apparatus of claim 24 wherein at least one of the first recovery content and the second recovery content comprises at least one of:
a particular data rate identifier;
a particular spread spectrum practice identifier;
a particular carrier modulation identifier;
a particular carrier frequency identifier;
a particular joint message format identifier;
a particular data order identifier;
a particular data inversion pattern identifier;
a particular data symbol or data symbol set;
a particular mode of encryption;
a particular encryption key.

29. An apparatus comprising:
a memory having message content stored therein;
a plurality of selectable forms of message alteration wherein the selectable forms of message alteration have corresponding recovery content associated therewith to be used to facilitate recovering message content that has been altered as per a selected one of the plurality of selectable forms of message alteration;
a message alteration form selector arranged and configured to automatically select at least a first and a second form of message alteration, wherein the first and second forms of message alteration are different from one another;
a first converter responsive to the memory, the plurality of selectable forms of message alteration, and the message alteration form selector and being arranged and configured to covert a first message content portion of the message content and recovery content as corresponds to a second form of message alteration into a first altered form using a first form of message alteration;
a second converter responsive to the memory, the plurality of selectable forms of message alteration, and the message alteration form selector and being arranged and configured to covert a second message content portion of the message content, which second message content portion is at least partially different from the first message content portion, in a second altered form using the second form of message alteration;
a transmitter operably coupled to receive recovery content as corresponds to the first form of message alteration, the first altered form, and the second altered form and to transmit such input as a joint message.

30. The apparatus of claim 29 wherein the plurality of selectable forms of message alteration comprise at least one of:
a plurality of candidate data rates;
a plurality of candidate spread spectrum practices;
a plurality of candidate carrier modulations;
a plurality of candidate carrier frequencies;
a plurality of candidate joint message formats;
a plurality of candidate data orders;
a plurality of candidate data inversion patterns;
a plurality of candidate data symbols representing a data value;
a plurality of candidate modes of encryption;
a plurality of candidate encryption keys.

31. The apparatus of claim 29 wherein the recovery content comprises at least one of:
a particular data rate identifier;
a particular spread spectrum practice identifier;
a particular carrier modulation identifier;
a particular carrier frequency identifier;
a particular joint message format identifier;
a particular data order identifier;
a particular data inversion pattern identifier;
a particular data symbol or data symbol set;
a particular mode of encryption;
a particular encryption key.

32. An apparatus comprising:
a joint message receiver;
a recovery content extractor operably coupled to the joint message receiver and having a first recovery content output;
a first signal processor operably coupled to the joint message receiver and to the recovery content extractor and being configured and arranged to use the first recovery content output to recover from the joint message a first message content part and second recovery content as was converted into a first altered form using a first form of message alteration;
a second signal processor operably coupled to the joint message receiver and to the first signal processor and being configured and arranged to use the second recovery content to recover from the joint message a second message content part as was converted into a second altered form using a second form of message alteration, which second form of message alteration is different than the first form of message alteration.

33. The apparatus of claim 32 wherein the first form of message alteration differs from the second form of message alteration with respect to at least one of:
a data rate;
a spread spectrum practice;
a carrier modulation;
a carrier frequency;
a joint message format;
a data order;
a data inversion pattern;
a data symbols set;
a mode of encryption;
an encryption key.

34. The apparatus of claim 32 wherein at least one of the first recovery content output and the second recovery content output comprises at least one of:
a particular data rate identifier;
a particular spread spectrum practice identifier;
a particular carrier modulation identifier;
a particular carrier frequency identifier;
a particular joint message format identifier;
a particular data order identifier;
a particular data inversion pattern identifier;
a particular data symbol or data symbol set;
a particular mode of encryption;
a particular encryption key.
